(19) United States
(12) Patent Application Publication
(10) Pub. No.: US 2005/0047845 A1
(43) Pub. Date: Mar. 3, 2005

(54) Self-contained system and method for substance application

(75) Inventors: Russell W. White, Austin, TX (US); William Reber, Rolling Meadows, IL (US)

Correspondence Address: TOLER & LARSON & ABEL L.L.P., 5000 PLAZA ON THE LAKE STE 265, AUSTIN, TX, 78746, US

(73) Assignee: Onami, LLC

(21) Appl. No.: 10/652,589

(22) Filed: Aug. 29, 2003

(51) Int. Cl. B43K 5/14

(52) U.S. Cl. 401/132

(57) ABSTRACT

A self-contained device for substance application and methods relating to the same are disclosed. An application device incorporating teachings of the present disclosure could have a first cavity and a second cavity at least partially defined by a support member. The support member may have attached applicators at its distal ends. A first substance may be located in the first cavity and a second substance may be located in the second cavity. The substances may be the same or different and may include 2-octyl cyanoacrylate and an antiseptic wash.

### TECHNICAL FIELD

The following disclosure relates to applicators, and more particularly to a system and method for self-contained substance application.

### BACKGROUND

A cotton swab, such as a Q-Tips® cotton swab, is a common household product that has a multitude of uses. Most swabs use cotton as an absorbent tip covering material with stem or supporting member materials of wood, rolled paper or plastic. Conventional swabs are constructed by applying an absorbent covering directly to the distal end of the stem. Glue may be used to more firmly hold the absorbent covering in place upon the swab.

The cotton swab has changed little since its inception, with most improvements related to lowering the cost of manufacturing or making the swab safer to use. For example, U.S. Pat. No. 5,127,899 (Schmerse, Jr.) addresses the issue of eardrum damage when swabs are improperly applied to clean the outer ear. Schmerse suggests that injuries may be avoided by positioning a flat disc beneath the cotton coverings. If the disc is large enough, the swab will not be able to enter the human ear canal.

Similarly, U.S. Pat. No. 4,718,889 (Blasius, Jr. et al.) discloses the use of a cushion positioned between the end of the stem and the absorbent covering. The cushion is intended to provide some degree of protection against damage in the event that the stem does protrude through the absorbent covering.

While focusing on safety concerns is a legitimate and worthwhile endeavor, improving usability of swab technology is too often ignored.

### BRIEF DESCRIPTION OF THE DRAWINGS

FIG. 1 illustrates a substance application device with two cavities that incorporates teachings of the present disclosure.

FIG. 2 shows a cut away view of an applicator embodiment that incorporates teachings of the present disclosure for maintaining a substance within a cavity at least partially defined by a support member.

### DETAILED DESCRIPTION OF THE INVENTION

Whether cleaning windows, treating medical conditions, applying or touching up cosmetics or fingernail polish, or putting on deodorant, a typical person may dispense or apply a substance to a chosen surface several times a day. People use applicators frequently. In some cases, the substance being applied may dictate the type of applicator to be used. A person may need a spray applicator in one circumstance and a pump applicator or a cotton ball in the next. In other circumstances, a user may want different types of applicators in a single device. For example, a portion of the device or a substance stored in the device may be used to remove a material from a surface to prepare the surface for the deposition of a second substance.

Devices and methods that incorporate the teachings described herein may offer a relatively inexpensive and easy to use technique for applying substances on or to a given surface. In addition, such devices and methods may allow for a less cumbersome and a timelier cleaning and treatment of wounds.

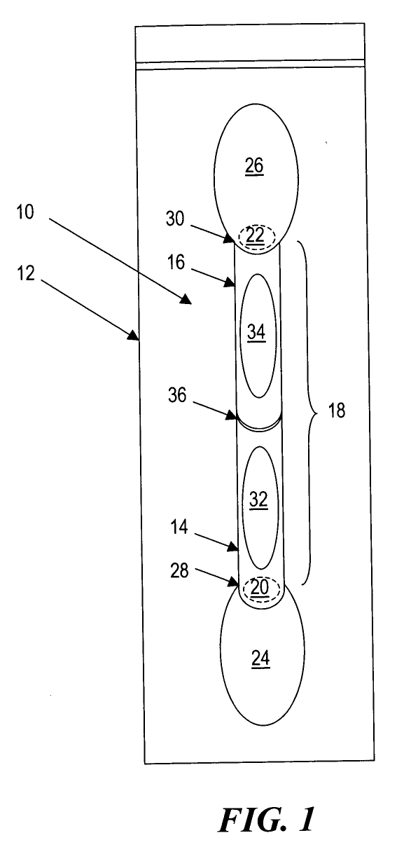

As mentioned above in the brief description of the figures, FIG. 1 illustrates a substance application device 10 located within a package 12. Package 12 may be sealed to protect application device 10 from contamination. This may be especially important when application device 10 is a sterile device to be used for health and wound related uses.

As depicted, application device 10 has a first cavity 14 and a second cavity 16 that may be at least partially defined by support member 18. A first substance may be located in first cavity 14 and a second substance may be located in second cavity 16. The substances may be the same or different and may be made up of any of several different compositions.

For example, the first substance may include a fast polymerizing monomer, such as 2-octyl cyanoacrylate (2-OCA). Such a monomer may be operable to form an adhesive film in response to combination with a polymerizing agent, which may take any number of forms. For example, the agent may be ambient moisture in one circumstance and a chemical agent located near a burstable membrane 20 in another. In some embodiments, the second substance may include an antiseptic or cleansing agent or wash.

Application device 10 may also include a first burstable membrane 20 enclosing first cavity 14 and a second burstable membrane 22 enclosing second cavity 16. The burstable membrane(s) could be comprised of materials that are capable of combining with the substances. For example a catalyst or additive could be coated on the outer surface of the membrane or released during rupture of the membrane. Thus, the additive to a substance such as the 2-OCA monomer is introduced via the burstable membrane itself.

When operating application device 10, a user may squeeze support member 18 at or near first cavity 14 and effectively reduce the available volume of first cavity 14. This reduction in volume may cause the first substance to press against burstable membrane 20 and eventually cause burstable membrane 20 to yield—releasing the first substance into applicator 24. Similarly, squeezing support member 18 at or near second cavity 16 may cause burstable membrane 22 to yield and release the second substance into applicator 26.

As depicted in FIG. 1, support member 18 defines a mouth 28 of first cavity 14 at a first distal end of support member 18 and a second mouth 30 of second cavity 16 at a second distal end of support member 18. In the embodiment shown, applicator 24 substantially encompasses mouth 30 and applicator 26, which may be adhesively attached to support member 18, substantially encompasses mouth 30. In some embodiments, applicator 26 may be formed to have an appearance different than applicator 24 to indicate to a user which end of application device 10 is which.

For some uses of application device 10, the first substance may not be the same as the second substance. For example, the first substance may be to clean a wound and the second substance may be used to seal the wound. As such, it may be necessary to identify and differentiate the ends of application device 10. As depicted in FIG. 1, application device 10 may have an indicator 32 that identifies the relative location of the first substance and an indicator 34 that identifies the relative location of the second substance. Though indicators 32 and 34 are depicted as being located on support member 18, indicators 32 and 34 could take several different forms. For example, indicators 30 and 34 may be located on package 12. Indicators 30 and 34 may rely on a single marking scheme or several marking schemes in combination. The schemes may include the use of different patterns, different colors schemes, printed words, printed numbers, or some other marking or identification techniques capable of distinguishing one end of application device 10 from the other end. As mentioned above, applicators 24 and 26 may also be formed of different materials or formed to have different shapes to differentiate the two ends of application device 10. In one embodiment, one end may be a brush and the other end may be cotton swab. In such an embodiment, the function of the brush may be to remove a material from a surface or for preparing the surface and the function of the cotton swab may be to apply a material. The two ends may thus differ by way of function, the first being brush-like and the second more of a swab-like applicator. Thus it is implicit which end of the device is used first without the need for an extrinsic indicator.

As depicted, application device 10 has two support member portions affixed to one another at their respective closed ends, seam 36. In the embodiment of FIG. 1, each portion has an open end and a closed end, and seam 36 connects the two support member portions at their respective closed ends. Manufacturers of application device 10 may use different techniques to create a two chambered application device. A manufacturer may elect to place a crimp in the support member 18 that at least partially isolates first cavity 14 from second cavity 16.

In some circumstances, an application device like application device 10 may have a first cavity that is isolated from the second cavity and formed such that the first cavity defines a volume larger than a volume defined by the second cavity.

As shown in FIG. 1, a support member, like support member 18, may have a substantially linear configuration and a round cross section. The round cross section may be substantially circular or more elliptical in shape. With an elliptical cross section, a cavity like cavity 14 may have a length dimension defining the distance from seal 36 to mouth 28 as well as a major and minor axis effectively defining the elliptical cross section of cavity 14. By grasping support member 18 at or near cavity 14 and squeezing along the major axis of cavity 14, a user may be able to more effectively reduce the volume of cavity 14 and more easily burst burstable seal 20.

Though the above paragraph focuses on a substance delivery mechanism that involves squeezing support member 18 to burst a burstable seal, there may be other approaches for using application device 10. With one particular embodiment, a user may initially remove a single use application device from a package like package 12. Application device 10 may, in some circumstances, be a single use device. For example, if application device 10 is sterile and designed for medicinal or healthcare uses, it may be necessary to limit the device to a single use. A user may not want to contaminate an application device by using it on an open and dirty wound and then re-use the device on a second wound.

Once out of package 12, a user may need to operate a delivery mechanism to initiate release of a substance from a cavity at least partially containing the substance. The delivery mechanism could take several forms. For example, the mechanism could involve squeezing a support member to reduce the available volume of a cavity. Alternative techniques are numerous and may include depressing a plunger to decrease the available volume of a cavity. One skilled in the art will recognize that other viable technique exist for expelling or releasing a substance from a cavity.

The applicator, like applicator 24, may be formed at least partially from a porous material. The porous material may allow an expelled substance to move from an interior area of applicator 24, near mouth 20, to an exterior surface of applicator 24. Moving the substance to an exterior surface may make applicator 24 ready for application of the substance to a chosen surface. In single use devices, a user may complete the use process by disposing of application device 10 after a single use.

In some embodiments, the substance located within cavity 14 may include a monomer capable of forming an adhesive film when combined with a polymerizing agent, and the polymerizing agent may be located near mouth 28 or imbued into at least a portion of applicator 24. One example of a monomer capable of forming an adhesive film is 2-octyl cyanoacrylate (2-OCA). 2-OCA may polymerize to effectively create a liquid bandage, like the BAND-AID® Brand Liquid Bandage.

When polymerized, 2-OCA may form a clear, flexible, breathable seal that keeps out water, dirt, and germs. The seal bends and flexes during movement and stays on until it naturally sloughs off as the wound heals. In preferred embodiments, the 2-OCA seal is waterproof. As depicted in FIG. 1, application device 10 includes two cavities 14, 16, which contain different substances. If one substance is 2-OCA, the other substance may be an antiseptic wash. A preferred antiseptic wash may be specially formulated to relieve pain while washing. As such, a user may be able to burst burstable seal 22 to release a substance for cleaning a wound and then burst burstable seal 20 to release a substance capable of forming a clear bandage-like seal over the wound. In effect, application device 10 could become an integral part of a parent's traveling medical kit. When a child falls down and scrapes her knee, application device 10 may be used to clean and treat the scrape.

To seal a typical child's wound, a parent may need around 0.25 ml of a cyanoacrylate product. As such, a manufacturer of application device 10 may design the device to have a 2-OCA containing cavity of around 0.3 ml—in an effort to avoid wasting the monomer.

One skilled in the art will recognize that a fast polymerizing monomer product may rely on any of several suitable polymerizing agents and/or initiators and may be made up of different formulas. A general formula of a cyanoacrylate monomer may come in different grades and include an alkyl group such as methyl, ethyl, isopropyl, butyl, octyl, etc. The different grades can vary in viscosity, cure speed, strength, etc. They will bond to various combinations of dissimilar and similar materials including metals, rubbers, most plastics, glass and ceramics. Initiators and polymerizing agents are available to further enhance cure speed and adhesion to certain surface materials.

Although other esters are possible, common cyanoacrylates include the short-chain methyl and ethyl cyanoacrylates. 2-OCA is often considered a medical-grade cyanoacrylate. At room temperature, 2-OCA may be a reactive liquid that will polymerize in the presence of moisture, wound fluid, or other anionic and basic materials. 2-OCA may be a preferred substance as its formulation has been approved by the FDA for topical wound closure and an intact poly-2-OCA film may be considered a microbial barrier.

Additional properties of 2-OCA include a recommended shelf life of about 2 years under room temperature storage conditions. As such, a manufacturer may elect to use an indicator portion of application device 10, such as indicator 32 or 34, to date stamp the product. In other words, a manufacturer may want to use indicator 32 to let potential end-users know a window within which the product is acceptable for use as a wound-sealing tool. A use-by date stamp may also appear on package 12.

In some circumstances, a date stamp or indicator make take the form of a barcode, radio frequency identification (RF ID) or other machine readable format to help reduce the opportunity for human error. In a hospital environment, a user may simply swipe a wand past the applicator to determine whether the applicator should be used, to determine the substance contained in the applicator, and/or to track the use of the applicator.

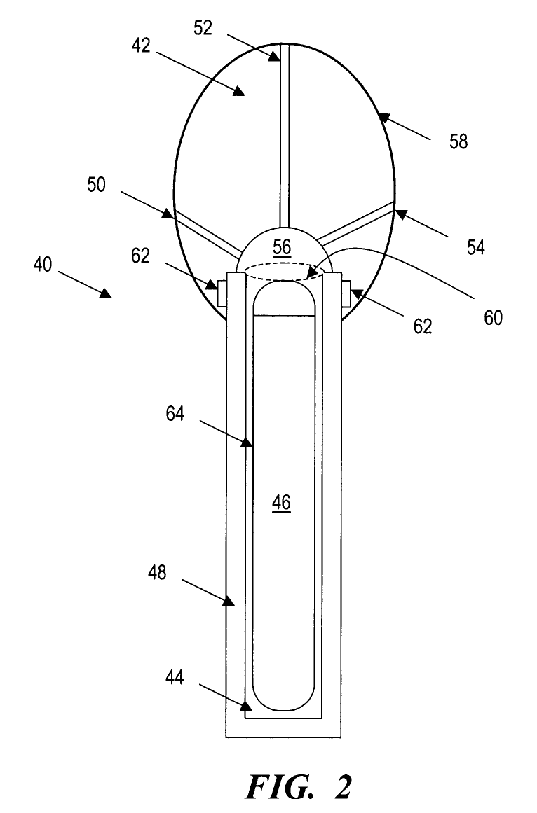

As depicted in FIG. 2, there may be several ways to maintain a substance within a cavity like cavity 14. There may also be several ways to facilitate transfer of a substance from an interior portion of an applicator to an exterior surface.

FIG. 2 shows a cut away view of a portion of an application device 40. With application device 40, only one applicator 42 and cavity 44 are shown. Other applicators and/or cavities could be added without departing from the spirit and scope of this disclosure. For example, application device 40 could include one or more cavities and one or more applicators in any of several combinations. With two isolated cavities and one applicator, an application device could keep two materials that may react with one another separated until and end-user desired their combination. And once combined, the end-user could apply them to a chosen surface. In other words, a burstable seal may exist between two cavities, and when the seal is broken, the substances may be combined for application.

As mentioned above in the brief description of the figures, FIG. 2 shows a cut away view of an application device 40 that incorporates teachings of the present disclosure for maintaining a substance 46 within a cavity 44 at least partially defined by a support member 48. As depicted, support member 48 has a thickness and may be formed from several different materials or combinations of materials including plastic, paper, wood, metal, or other suitable material. Similarly, applicator 42 may be formed from several materials or combinations of materials including cotton, plastic, sponge, brushes or other suitable material.

In FIG. 2, applicator 42 is coupled near a distal end of and to an exterior surface of support member 48 with an adhesive material 62 that encircles support member 48. One skilled in the art will recognize that other acceptable methods of securing applicator 42 to support member 48 exist. As shown, applicator 42 is attached to support member 48 such that applicator 42 substantially encompasses the mouth 60 of support member 48. Applicator 42 may be formed with any number of shapes, but as shown in FIG. 2, applicator 42 is formed to have a generally elliptical shape and to include transmission channels 50, 52, and 54, which may facilitate transfer of substance 46 from an interior portion 56 of applicator 42 to an exterior surface 58. In some embodiments, substance 46 may be maintained within cavity 44 with a burstable membrane effectively encapsulating mouth 60. As shown in FIG. 2, substance 46 is located in its own package 64, which may be formed of a plastic, metal, foil, other suitable material, or combination thereof. In effect, package 64 may act as an encapsulating burstable membrane that surrounds and holds substance 46 such that substance 46 does not touch an interior wall of cavity 44 at least until the membrane is busted. As shown, substance 46 does not completely fill package 64. This may be preferred in some embodiments and disfavored in others. In other embodiments and as described above, substance 46 may be maintained within cavity 44 by a burstable membrane that seals mouth 60 as opposed to or in addition to forming an encapsulating package for substance 46. The manufacturing of a device may dictate or at least favor one encapsulation method over another. For example, it may be easier to package a substance in an encapsulating membrane, like package 64, at an earlier time and then provide a manufacturing assembly line with pre-packaged substances to be inserted into the cavity of an application device.

Although the present invention has been described in detail, it should be understood that various changes, substitutions and alterations to the devices, methods, and other aspects and techniques of the present invention can be made without departing from the spirit and scope of the invention as defined by the appended claims.

1. A self-contained substance application system, comprising:
a support member at least partially defining a first cavity and a second cavity;
a first substance located in the first cavity;
a second substance located in the second cavity;
a first burstable membrane enclosing the first cavity;
a second burstable membrane enclosing the second cavity;
an applicator attached to the support member; and
an indicator identifying a location of the first cavity.

2. The system of claim 1, further comprising first and second support member portions each having an open end and a closed end, the first and second support member portions affixed to one another at their respective closed ends to at least partially define the support member.

3. The system of claim 1, further comprising a crimp in the support member that at least partially isolates the first cavity from the second cavity.

4. The system of claim 1, wherein the first cavity is isolated from the second cavity and the first cavity defines a volume larger than a second cavity defined volume.

5. The system of claim 1, wherein the support member has a substantially linear configuration and a substantially circular cross section.

6. The system of claim 5, wherein the support member defines a mouth of the first cavity at a first distal end of the support member and a second mouth of the second cavity at a second distal end of the support member, the applicator substantially encompassing the mouth, further comprising:
a second applicator attached to the support member and substantially encompassing the second mouth, the second applicator formed to have an appearance different than the applicator.

7. A substance application method, comprising:
removing a single use application system comprising a support member and a porous applicator tip from a package;
operating a delivery mechanism to initiate release of a substance from a cavity at least partially defined by the support member;
releasing the substance into the porous applicator tip;
applying the substance to a desired surface via the porous applicator tip; and
disposing of the support member after a single use.

8. The method of claim 7, wherein the applicator tip comprises a sponge material and wherein the support member defines an elliptical cross section having a major axis and a minor axis, further comprising:
squeezing the support member along the major axis to operate the delivery mechanism.

9. The method of claim 7, wherein the support member defines a round cross section, further comprising:
depressing a plunger to operate the delivery mechanism by decreasing an available volume for the substance in the cavity.

10. The method of claim 7, wherein the substance comprises a monomer, further comprising combining the substance with an initiator to begin converting the monomer to a polymer.

11. The method of claim 7, further comprising:
operating a second delivery mechanism to initiate release of a second substance from a second cavity at least partially defined by the support member;
releasing the second substance into a second applicator tip;
applying the second substance to a desired surface via the second applicator tip.

12. The method of claim 11, wherein the substance comprises a monomer operable to form an adhesive film in response to combination with an agent that initiates conversion of the monomer to a polymer, further wherein the second substance comprises an antiseptic agent.

13. A substance application system, comprising:
a cavity formed at least in part from a support member, the cavity containing a substance comprising a fast polymerizable liquid monomer;
an expulsion orifice configured to release the substance into an applicator portion of the system that contains an initiator operable to begin transition of the monomer to a polymer; and
an applicator tip associated with the applicator portion for depositing an adhesive film on a surface.

14. The system of claim 13, wherein the fast polymerizable liquid monomer comprises Cyanoacrylate and further wherein the cavity defines a volume of less than 0.5 mL.

15. The system of claim 13, further comprising:
a delivery mechanism to initiate release of the contained substance, the mechanism comprising a burstable membrane associated with the expulsion orifice.

16. The system of claim 13, further comprising:
a second cavity containing a second substance, the second substance different from the first substance.

17. The system of claim 13, further comprising:
a second cavity containing a second substance comprising an antiseptic wash;
a first indicator identifying a location of the first cavity; and
a second indicator identifying the location of the second substance.

18. The system of claim 13, wherein the support member comprises plastic and the applicator tip comprises cotton.

19. A substance application method, comprising:
locating a first substance in a first cavity at least partially defined by a support member;
locating a second substance in a second cavity at least partially defined by the support member; and
attaching an applicator to the support member.

20. The method of claim 19, further comprising enclosing an opening of the first cavity with a burstable membrane.

21. The method of claim 19 wherein the support member has a first distal end portion and a second distal end portion and the applicator is attached at the first distal end portion, further comprising attaching a second applicator to the support member at the second distal end portion.

22. The method of claim 19, further comprising:
placing the support member with attached applicator in a container; and
sealing the container.

23. The method of claim 19, further comprising forming the support member to have a round cross section and to at least partially define the first cavity and the second cavity.

24. The method of claim 23, further comprising isolating the first cavity from the second cavity.

25. The method of claim 23, further comprising indicating on the support member a location of the first cavity.

26. The method of claim 23, further comprising forming the support member to have a long axis and an elliptical cross section at least at some point along the long axis.

27. The method of claim 23, wherein the first substance comprises a polymerizable liquid monomer, further comprising:
associating an initiator with the applicator, the initiator operable to facilitate conversion of the monomer to a polymer.

28. A dual substance application system, comprising:
a support member at least partially defining a first cavity and a second cavity;
a first substance located in the first cavity;
a second substance located in the second cavity;
a seal keeping the first substance in the first cavity; and
a package containing the support member and operable to protect the support member from contamination.

29. The system of claim 28, further comprising an indicator identifying a location of the first cavity.

30. The system of claim 28, further comprising:
a second seal keeping the second substance in the second cavity; and
a sterile applicator attached to the support member.

31. The system of claim 30, further comprising a resealable box that contains a plurality of packages.

32. The system of claim 30, wherein the substance comprises a monomer operable to form an adhesive film in response to combination with a polymerizing agent, further wherein the second substance comprises an antiseptic wash.
